(19) United States
(12) Patent Application Publication
(10) Pub. No.: US 2015/0308850 A1
(43) Pub. Date: Oct. 29, 2015

(54) Method and Apparatus for Contact Address Population and Verbal Address Selection

(71) Applicant: Ford Global Technologies, LLC, Dearborn, MI (US)

(72) Inventors: Mark E. Krugman, Bloomfield Hills, MI (US); James Ryan Chinavare, Manchester, MI (US); James W. Helmke, Highland, MI (US); Eric Krugman, Royal Oak, MI (US)

(73) Assignee: Ford Global Technologies, LLC, Dearborn, MI (US)

(21) Appl. No.: 14/260,417

(22) Filed: Apr. 24, 2014

(51) Int. Cl. G01C 21/36

(52) U.S. Cl. CPC G01C 21/3608

(57) ABSTRACT

A system includes a processor configured to receive a verbal instruction identifying a navigation instruction and a contact name. The processor is also configured to retrieve a physical address saved in a vehicle computing system contact entry corresponding to the contact name. Further, the processor is configured to verify the validity of the retrieved address as a navigation destination and set the retrieved address as the navigation destination after the validity has been verified.

### TECHNICAL FIELD

The illustrative embodiments generally relate to a method and apparatus for contact address population and verbal address selection.

### BACKGROUND

Hands free vehicle interface technology has advanced at a rapid pace, to a point where users can typically input most commands to a vehicle system without actually needing to provide anything other than verbal instruction, if desired. For example, if a contact, such as “John Smith,” exists in a vehicle address book, along with a phone number, the user can call that contact through the vehicle by stating “call John Smith,” or, in the case where there is a work and a home number, the user may state “call John Smith home.”

U.S. Patent Application Number 2013/0151149 generally relates to a vehicle navigation system that connects to a user's smart-phone or an online internet-based calendar service to download a user event schedule/calendar containing a list of upcoming user appointments. The next event within the list is identified, and is searched for the presence of a location identifier, i.e., an appointment venue or the name of the person with whom the appointment is fixed. Upon finding a location identifier, the user is prompted to confirm whether the identified location corresponds to the user's next intended destination, when the time of arriving at the identified location is close to the time when the next appointment occurs. Once the user confirms, the identified location is construed as the next intended destination and a destination input to the navigation system is automatically provided to plan the next trip accordingly.

### SUMMARY

In a first illustrative embodiment, a system includes a processor configured to receive a verbal instruction identifying a navigation instruction and a contact name. The processor is also configured to retrieve a physical address saved in a vehicle computing system contact entry corresponding to the contact name. Further, the processor is configured to verify the validity of the retrieved address as a navigation destination and set the retrieved address as the navigation destination after the validity has been verified.

In a second illustrative embodiment, a computer-implemented method includes receiving a verbal instruction identifying a navigation instruction and a contact name. The method also includes retrieving a physical address saved in a vehicle computing system contact entry corresponding to the contact name. Further, the method includes verifying the validity of the retrieved address as a navigation destination and setting the retrieved address as the navigation destination after the validity has been verified.

In a third illustrative embodiment, a non-transitory computer readable storage medium stores instructions that, when executed by a processor, cause the processor to perform a method including receiving a verbal instruction identifying a navigation instruction and a contact name. The method also includes retrieving a physical address saved in a vehicle computing system contact entry corresponding to the contact name. Further, the method includes verifying the validity of the retrieved address as a navigation destination and setting the retrieved address as the navigation destination after the validity has been verified.

### BRIEF DESCRIPTION OF THE DRAWINGS

FIG. 1 shows an illustrative vehicle computing system;

FIG. 2 shows an illustrative process for updating a contact list with physical addresses;

FIG. 3 shows an illustrative process for updating an invalid address;

FIGS. 4A and 4B show an illustrative process for voice selection of a navigation address; and

FIG. 5 shows an illustrative process for correction of a voice selected invalid navigation address.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

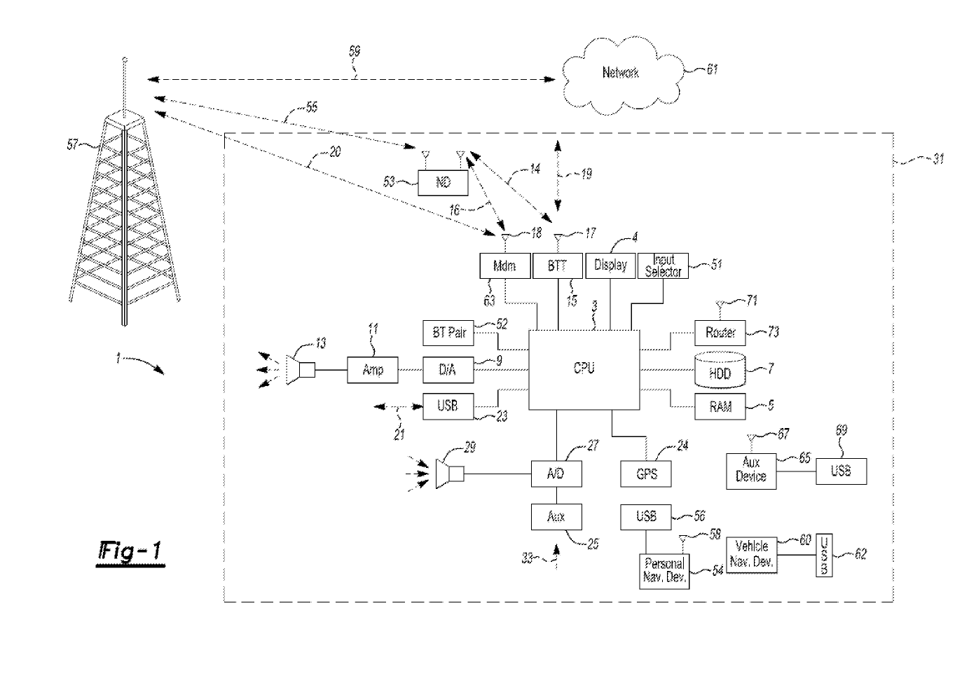

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domian Multiple Access (CDMA), Time Domain Multiple Access (TDMA), Space-Domian Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

The illustrative embodiments demonstrate exemplary methods for downloading stored user addresses from a connected phone. Also, in the illustrative embodiments, the driver is provided with an opportunity to verbally request an address associated with a contact, and that address will be utilized as a navigation destination.

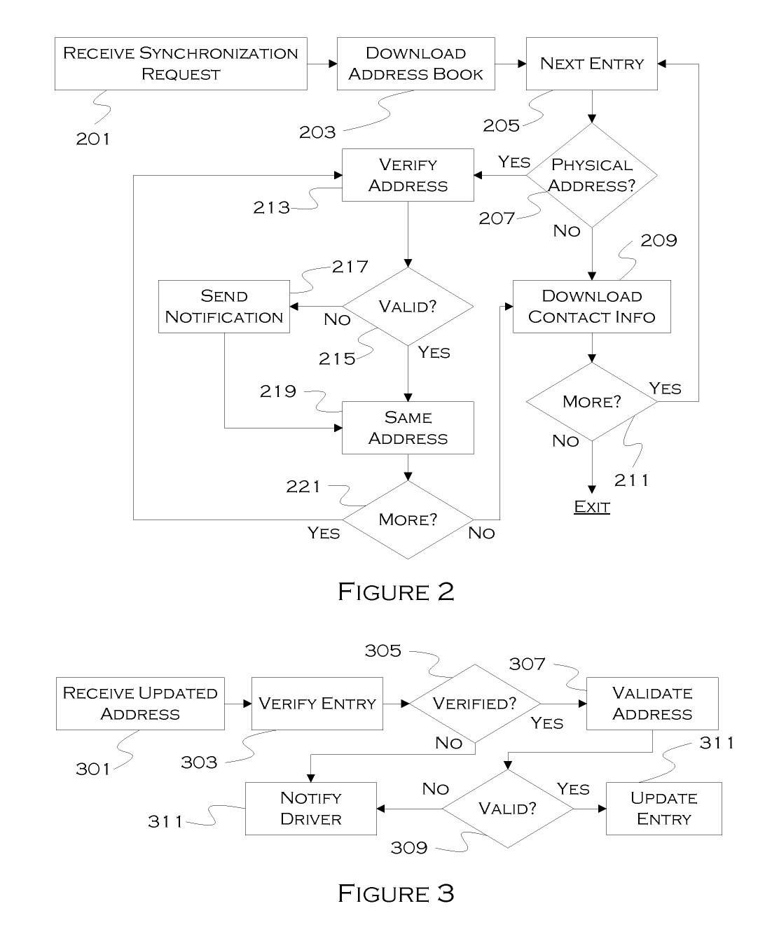

FIG. 2 shows an illustrative process for updating a contact list with physical addresses. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative embodiment, an address book will be downloaded from a user's phone and physical addresses will be added to a vehicle address book. These addresses are stored in the user's mobile device, with respect to the contacts in the device. For any given contact, one or more physical addresses (e.g., work address, home address, etc.) may be stored.

In this example, the process receives a request to synchronize an address book from a mobile device to a vehicle 201. This can happen, for example, when a vehicle connects to a mobile device on which one or more new (e.g., previously unrecorded on the vehicle) pieces of contact data exist. In this illustrative example, the processor, in response to the synchronization request, downloads the address book from the mobile device to the vehicle 203.

Moving to a next entry in a device 205, the process checks to see if there is a physical address associated with the entry 207. If there is no physical address, the process will download any contact information, such as phone number, email, etc., that has not been previously stored 209. If additional contacts remain 211, the process repeats.

If there is a physical address associated with the contact, the process verifies the physical address 213. In this example, the process may, for example, check the address against a known navigation map, to determine if the navigation system would be capable of navigating to the address if such navigation were requested. If the address is valid 215, the process will save the address with the contact in the vehicle system 219. If the address is invalid, the process may send a notification to the driver that the address is invalid 217.

Because a driver may not wish to amend the address while the synchronization is in process (presumably the driver got into the vehicle for purposes other than updating the address book), the message may not be an in-vehicle message. An in-vehicle message may be provided if desired, but in this embodiment, additionally or alternatively, a message is sent to an identified driver account. This could be, for example, an email account, so that the driver can fix the address at a later time, when the driver has a keyboard available for easier input, and when the driver may not be attempting to complete a journey. If additional contacts remain, the process may repeat 221.

In another embodiment, all addresses may be first downloaded to speed up synchronization, and then, as the vehicle travels or at some other time, verification of the addresses may be completed, if verification is desired. In still another embodiment, verification may be reserved until such time as a particular address is requested.

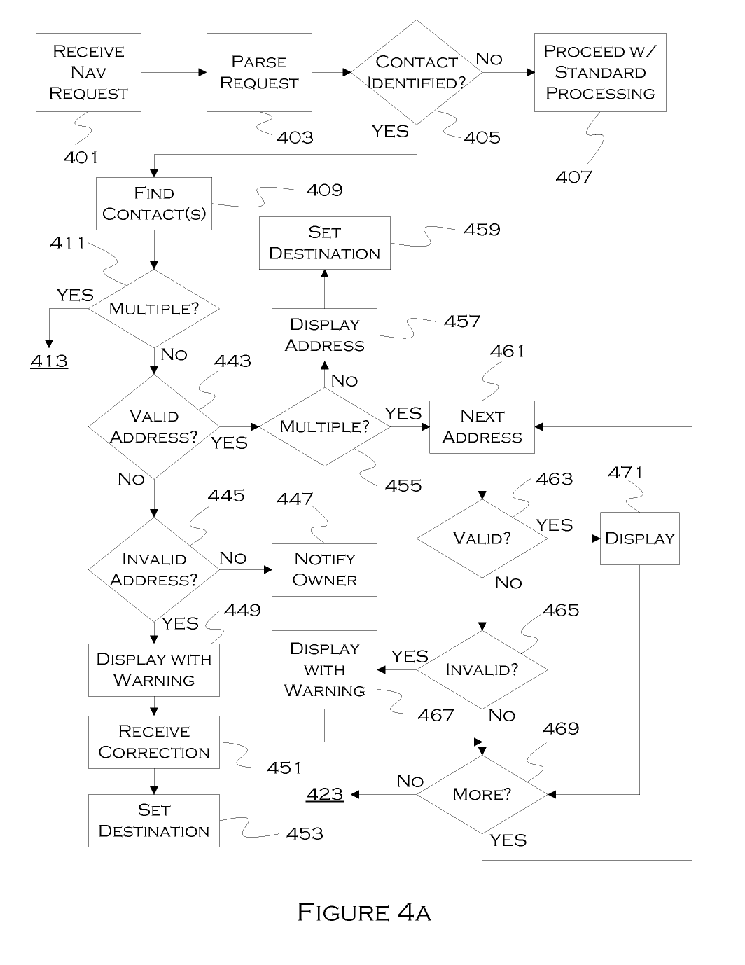

FIG. 3 shows an illustrative process for updating an invalid address. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process has notified a driver of one or more recognized errors with addresses downloaded to a vehicle computer for storage. The driver has corrected the address(es) and sent a response to the vehicle computing system. The correction can be done via the vehicle computer, or via another computer capable of direct or indirect communication with the vehicle computing system (e.g., through an intermediary server). The correction can also be relayed to the vehicle computing system through a server.

The process (running on the vehicle computer or an intermediary server), receives the updated address as corrected by the driver 301. The process first verifies that the correct information for the vehicle to be updated has been received 303. That is, the process verifies that the email is from a trusted source and is intended for the vehicle that received the information.

If the email is not verified, the process may notify the driver that an unverified source attempted to contact the vehicle computing system 311. If the email or other message is verified, the process may then validate the newly entered address 307. Again, the validation may take the form of ensuring that the navigation system has the address accessible in a database. If the address is valid 309, the process may update the associated contact entry 313. Otherwise, the process may notify the driver that the address still has one or more errors. The notification, if desired, can again take the form of an email to the driver or other extra-vehicular message.

While verification of addresses in advance or off-line is not necessary, it may serve to improve the driver experience when a particular address is requested. Verification can take any number of forms, although it is desirable to have a verified address be one that the vehicle will recognize as valid if the address is requested by the driver.

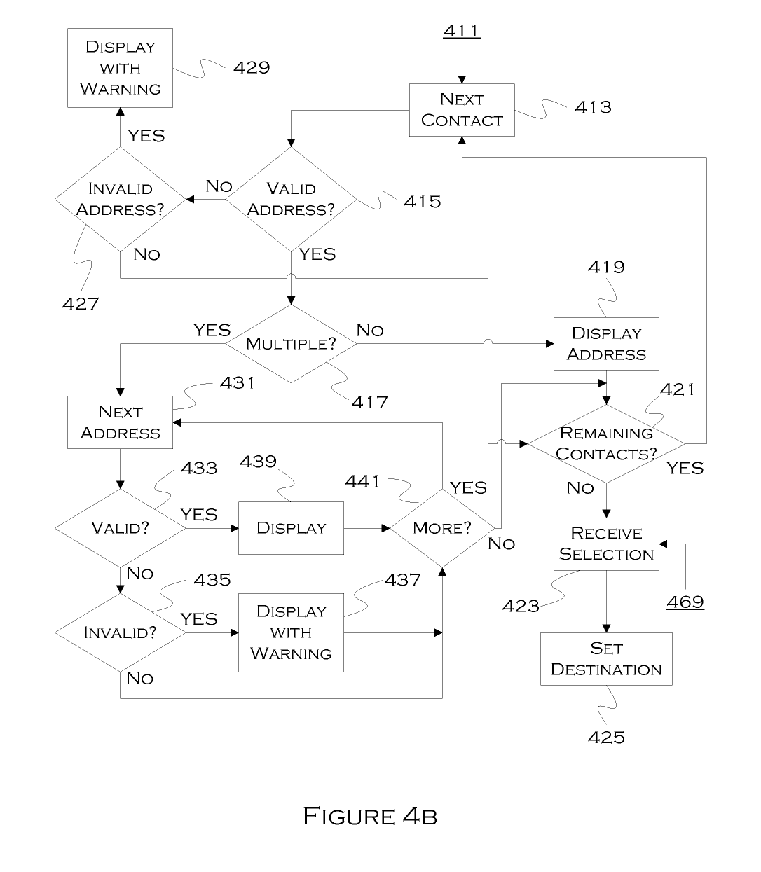

FIGS. 4A and 4B show an illustrative process for voice selection of a navigation address. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process receives a navigation request from the driver. Specifically, in this embodiment, the driver speaks a plain language request, such as “navigate to John Smith's house.” Upon receiving the request, the process parses the request to identify a requested address 403. The words “John Smith” identify a contact and the word “house” identifies a home address. Any suitable method of extracting and determining this information from a spoken instruction may be used.

If a contact, such as John Smith, is not identified in the navigation request 405, the process may proceed with a standard navigation request, providing directions to a stated address or a navigation voice-menu or driver interface for input of an address 407.

If a contact is identified, however, the process may attempt to find that contact in a saved address book 409. Because there may be more than one user having a similar name (e.g., Jon Smith, John Smith, J. Smithe), the process may identify multiple possible entries. If multiple entries are identified, the process will select all possible matches and begin with a first possible match 413. For the identified match, the process will first check to see if a “home” address, or any address for that matter, is stored 415. The process may also check to see if this is a valid address 415. If no valid address is stored, the process may check to see if an invalid address is stored. If neither a valid nor invalid address is stored, the process may move to a next contact.

If an invalid address is stored, the process may display the particular address on a list of addresses from which selection is to be made, along with some warning that some portion of the address may need to be corrected 429. This could be as simple as presenting the address in a different color, or any other suitable indicia of a possible invalid address could be used.

If a valid address is stored, the process may check to see if multiple addresses exist for the user. If only a single address is stored, the address may be presented for selection 419. The processor may alternatively only present the address if it is also saved as a “home” address.

If multiple addresses are stored, the processor will begin with a first address 431. For each address, the processor may check the validity 433 and display the address for selection if valid 429. If invalid 435, the processor may display the address with an accompanying warning 437. Of course, if no warning is desired, one need not be displayed. This process will repeat for all stored addresses, if needed 441, and then the process will continue for any additional identified contacts 421.

Even if multiple addresses are stored, the “house” or “home” identification may serve to limit the displayed address to that identified with a contact's home. But, if the contact does not have a “home” address identified, or if the driver fails to specify “house” (e.g., “Navigate to John Smith”), the process may provide all addresses for the contact.

Once all appropriate addresses for each matching or similar contact have been identified and displayed, the process may receive a selection of the appropriate address to which the user was referring 423. The vehicle can then navigate to the address, setting it as the destination 425.

Since speech recognition is still an imperfect science, variations in driver accents and speech patterns may frequently cause instructions to identify more than one address or contact. Background noise can also garble the input, so, in this embodiment, accommodation is made when a specific, single address cannot be precisely identified.

If only a single contact is identified 411, the process may check to see if the address (e.g., in this case, “home”) is a valid address 443. If the address is valid, the process may check to see if there are multiple addresses associated with this user 455. If there are not multiple addresses, or if multiple addresses are not appropriate (e.g., “home” was identified in the command with sufficient precision), the process may display the valid address 457 and use the address as the navigation destination 459.

If multiple addresses exist or are appropriate (e.g., no specific address type was identified), the process may begin with a first address 461. If that address is valid 463, the process may display the address for possible selection 471. If the address is invalid 465, the process may display the address for selection with a warning 467, as previously discussed.

This process may repeat for all of the multiple addresses 469.

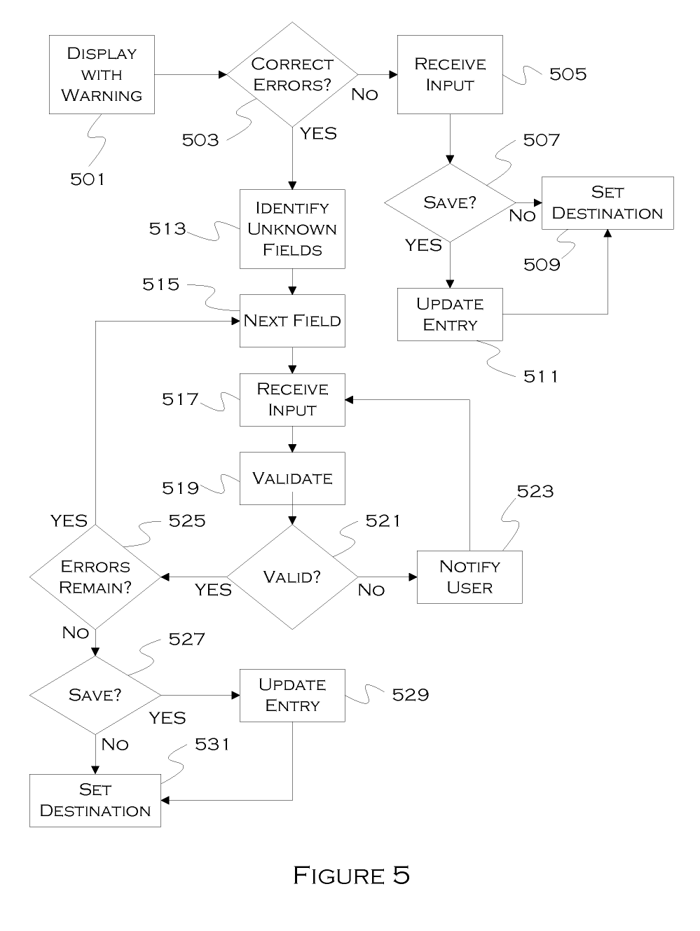

If there was a single, invalid address 445, the process may display the address with a warning 449. In this example, the system may receive a correction to the invalid address 451 and then may utilize the corrected address as the destination 453. Correction of an invalid, requested address is discussed in more detail with respect to FIG. 5.

FIG. 5 shows an illustrative process for correction of a voice selected invalid navigation address. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the process displays the requested address with a warning to the user that the address is invalid 501. If the user wishes to utilize the address, the user may wish to correct the errors in the address 503. Alternatively, the user may simply rather hand-enter the entire address 505. If new address entry is chosen, the process will receive input of the full address from the user 505.

The user may then be asked whether or not this newly entered address should be saved as the requested contact address 507. If the user desires to save the address 507, the contact address entry is updated with the corrected address 511. Whether or not the address is saved to a contact file, the destination can then be set 509.

If the user merely wishes to correct errors in the requested address 503, the process can identify the erroneous fields in the address entry. For example, if known addresses were 123 Cherry Ln, Somewhere, MI and 125 Cherry Ln, Somewhere, MI, but the address read 124 Cherry Ln, Somewhere, MI, the process might identify the street number as invalid. In other instances, when the street name or city is spelled wrong, the process may have to iteratively identify errors, checking each field as the previous one is corrected. For example, the process may not even know whether or not 124 Cherry Ln is an appropriate address if Somewhere is misspelled. Once Somewhere is corrected, the process can then check the street to ensure it exists, and then check the house number.

As each error is identified, the process may move to the field for correction 515 and request corrected input from the driver. This correction input can be verbal or physical. The input is received 517 and the new input is validated (e.g., for the above correction, input of 126 would still be invalid). If the new data is invalid 521, the user will be notified and will attempt to correct the data again. If the new data is valid, the process determines if any error still remain 525.

Once all errors have been corrected, the process may ask if the corrected address should be saved 527. In at least one embodiment, the corrected address is automatically saved. The vehicle contact entry is then updated 529 (if desired) and the destination is set 531.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a verbal instruction identifying a navigation instruction and a contact name;
retrieve a physical address saved in a vehicle computing system contact entry corresponding to the contact name;
verify validity of the retrieved address as a navigation destination; and
set the retrieved address as the navigation destination after the validity has been verified.

2. The system of claim 1, wherein the processor is further configured to identify an invalid portion of the retrieved address if the validity is not verified.

3. The system of claim 2, wherein the processor is further configured to receive verbal correction of the invalid portion.

4. The system of claim 2, wherein the processor is further configured to receive touch input correction of the invalid portion.

5. The system of claim 1, wherein the processor is configured to verify the validity of the address by attempting to utilize the address as a destination and determining if any errors result.

6. The system of claim 1, wherein the verbal instruction includes a categorical designation identifying a particular address saved in the contact entry.

7. The system of claim 6, wherein the processor is configured to retrieve an address saved in the contact entry having a categorical designation associated therewith, corresponding to the input categorical designation.

8. A computer-implemented method comprising:
receiving a verbal instruction identifying a navigation instruction and a contact name;
retrieving a physical address saved in a vehicle computing system contact entry corresponding to the contact name;
verifying validity of the retrieved address as a navigation destination; and
setting the retrieved address as the navigation destination after the validity has been verified.

9. The method of claim 8, further including identifying an invalid portion of the retrieved address if the validity is not verified.

10. The method of claim 9, further including receiving verbal correction of the invalid portion.

11. The method of claim 9, further including receiving touch input correction of the invalid portion.

12. The method of claim 8, wherein the verifying the validity of the address includes attempting to utilize the address as a destination and determining if any errors result.

13. The method of claim 8, wherein the verbal instruction includes a categorical designation identifying a particular address saved in the contact entry.

14. The method of claim 13, further including retrieving an address saved in the contact entry having a categorical designation associated therewith, corresponding to the input categorical designation.

15. A non-transitory computer readable storage medium, storing instructions that, when executed by a processor, cause the processor to perform a method comprising:
receiving a verbal instruction identifying a navigation instruction and a contact name;
retrieving a physical address saved in a vehicle computing system contact entry corresponding to the contact name;
verifying validity of the retrieved address as a navigation destination; and
setting the retrieved address as the navigation destination after the validity has been verified.

16. The storage medium of claim 15, the method further including identifying an invalid portion of the retrieved address if the validity is not verified.

17. The storage medium of claim 16, the method further including receiving verbal correction of the invalid portion.

18. The storage medium of claim 16, the method further including receiving touch input correction of the invalid portion.

19. The storage medium of claim 15, wherein the verifying the validity of the address includes attempting to utilize the address as a destination and determining if any errors result.

20. The storage medium of claim 15, wherein the verbal instruction includes a categorical designation identifying a particular address saved in the contact entry and wherein the method further includes retrieving an address saved in the contact entry having a categorical designation associated therewith, corresponding to the input categorical designation.
